(19) United States
(12) Patent Application Publication
(10) Pub. No.: US 2022/0099530 A1
(43) Pub. Date: Mar. 31, 2022

(54) CIRCUMFERENTIAL MAIN GROOVE DETECTION METHOD AND CIRCUMFERENTIAL MAIN GROOVE DETECTION DEVICE

(71) Applicant: BRIDGESTONE CORPORATION, Tokyo (JP)

(72) Inventor: Kyohei HONDA, Tokyo (JP)

(73) Assignee: BRIDGESTONE CORPORATION, Tokyo (JP)

(21) Appl. No.: 17/421,817

(22) PCT Filed: Nov. 21, 2019
(86) PCT No.: PCT/JP2019/045649

§ 371 Date: Jul. 9, 2021

(30) Foreign Application Priority Data
Mar. 29, 2019 (JP) 2019-068585

(51) Int. Cl. G01M 17/02; B60C 11/24; G01B 11/22; G01B 11/24

(52) U.S. Cl. CPC G01M 17/027; G01B 11/24; G01B 11/22; B60C 11/246

(57) ABSTRACT

A circumferential main groove detection method for detecting, by a computer, a position of a circumferential main groove of a tire from 3D data of a tread surface of the tire, the method including: a cross-sectional data extracting step of extracting, at a plurality of places in a tire circumferential direction, cross-sectional data of the tread surface along one direction inclined with respect to the tire circumferential direction; an area dividing step of dividing the cross-sectional data respectively into a plurality of areas along one direction; an evaluating step of evaluating relative unevenness in the areas; and a circumferential main groove identifying step of overlaying evaluation results of divided areas at an identical position in the tire circumferential direction and identifying the position of the tire circumferential main groove.

### TECHNICAL FIELD

The present invention relates to a circumferential main groove detection method and a circumferential main groove detection device, and more particularly to a circumferential main groove detection method and a circumferential main groove detection device that detect a main groove formed along a circumferential direction of a tire.

### BACKGROURND

Conventionally, as a method for inspecting a wear state and the like of tires, the method disclosed in Patent Document 1 has been known. According to Patent Document 1, first, an external shape of a tread part is acquired, from an inspection-target tire, as three-dimensional point group data; the point group data are plotted on cylindrical coordinates; thereafter the point group data are adapted to a curved surface conforming to a curve of the tire; and the data adapted to the curved surface are collectively overlaid in one place in the circumferential direction of the tire. Whereby, an uneven shape of a tire surface is acquired, and, on the basis of the uneven shape of the tire surface, a position of a main groove of the tire extending in a circumferential direction (hereinafter referred to as circumferential main groove) is acquired, and a wear state, such as a groove depth and the like, of the tire is detected.

### CITATION DOCUMENT

### Patent Document

Patent Document 1; Specification of U.S. Pat. No. 9,805,697

### SUMMARY OF THE INVENTION

### Technical Problem

However, in the cited document 1, since a plurality of numbers of processes are required, which are: acquiring three-dimensional point group data of a tread part for one round of a tire; plotting the point group data on cylindrical coordinates on the assumption that a rotation center axis set in the tire coincides with a coordinate axis of the cylindrical coordinates; and adapting the point group data plotted on the cylindrical coordinates to a curved surface conforming to a curve of the tire, there is a problem that complex calculations are necessary to detect a circumferential main groove and a groove depth of the tire. In addition, since the acquired groove depth is calculated on the basis of an averaged unevenness shape, there is a problem that an actual groove depth at a specific place cannot be acquired.

The present invention has been made in view of the above-mentioned problems and aims at providing a circumferential main groove detection method and a circumferential main groove detection device capable of detecting a position of the circumferential main groove formed in a tire by a simple method.

### Solution to Problem

As an aspect of the circumferential main groove detection method for solving the above-mentioned problems, there is provided a circumferential main groove detection method for detecting, by a computer, a position of a circumferential main groove of a tire from 3D data of a tread surface of the tire, the method including: a cross-sectional data extracting step of extracting, at a plurality of places in a tire circumferential direction, cross-sectional data of the tread surface along one direction inclined with respect to the tire circumferential direction; an area dividing step of dividing the cross-sectional data respectively into a plurality of areas along one direction; an evaluating step of evaluating relative unevenness in the areas; and a circumferential main groove identifying step of overlaying evaluation results of divided areas at an identical position in the tire circumferential direction and identifying the position of the tire circumferential main groove.

In addition, as an aspect of the circumferential main groove detection device for solving the above-mentioned problems, there is provided a circumferential main groove detection device that detects a position of a circumferential main groove of a tire from 3D data of a tread surface of the tire, the device including: a cross-sectional data extracting means that extracts, at a plurality of places in a tire circumferential direction, cross-sectional data of the tread surface along one direction inclined with respect to the tire circumferential direction; an area dividing means that divides the cross-sectional data respectively into a plurality of areas along one direction; an uneven state evaluating means that evaluates relative unevenness in the areas; and a circumferential main groove detecting means that overlays evaluation results of divided areas at an identical position in the tire circumferential direction and identifies the position of the circumferential main groove of the tire.

### BRIEF DESCRIPTION OF THE DRAWINGS

FIGS. 1A and 1B are block diagrams illustrating hardware configurations of a circumferential main groove detection device;

FIGS. 2A and 2B are conceptual diagrams of 3D data of a tread surface and cross-sectional data;

FIG. 3 is a diagram illustrating a manner of acquiring the 3D data of the tread surface;

FIGS. 4A to 4C are conceptual diagrams illustrating area division of the cross-sectional data by an area dividing means;

FIGS. 5A to 5D are diagrams illustrating processing in an uneven state evaluating means;

FIG. 6 is a conceptual diagram illustrating processing of calculating a groove depth by a groove depth calculating means; and

FIG. 7 is a flowchart illustrating processing in the circumferential main groove detection device.

### DESCRIPTION OF EMBODIMENT

The present invention will be described in detail below through an embodiment of the invention; however, the following embodiment is not intended to limit the inventions set forth in the claims, and all of combinations of the features described in the embodiment are not necessarily essential to the solving means of the invention, and includes configurations which are selectively adopted.

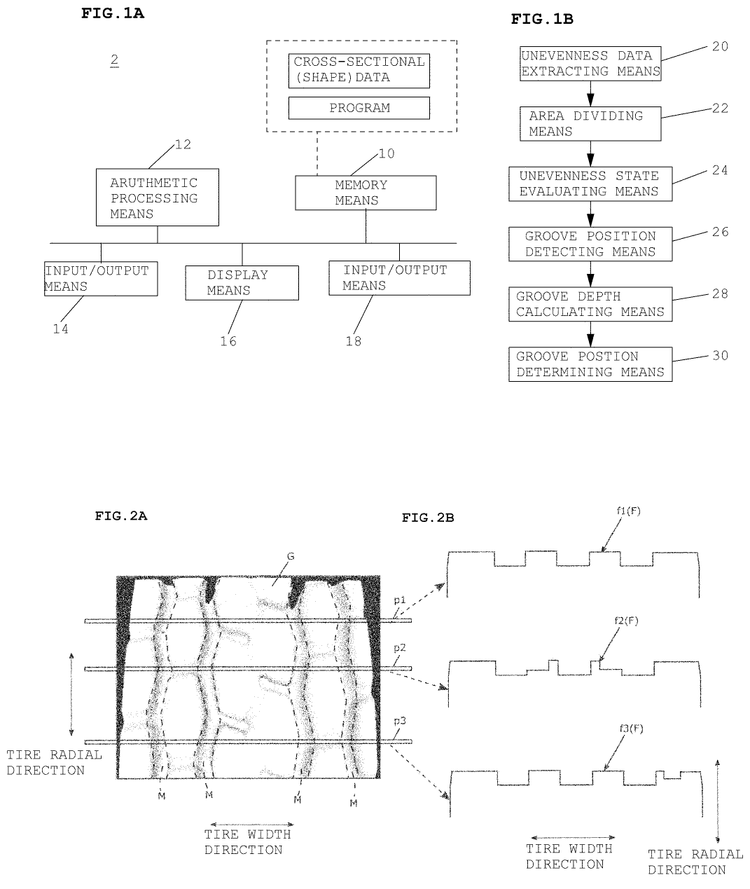

FIGS. 1A and 1B are a hardware configuration diagram and a block diagram of a circumferential main groove detection device 1 that executes the circumferential main groove detection method according to the present embodiment. As illustrated in FIG. 1A, the circumferential main groove detection device 1 is a so-called computer, and includes a memory means 10 such as a ROM, a RAM and the like provided as hardware resources, an arithmetic processing means 12 such as a CPU, an input/output means 14 functioning as an interface which enables exchange of information with the outside, a display means 16, an input means 18 and so on.

The memory means 10 stores, for example, 3D data G (see FIG. 2A) illustrating a 3D shape of a tread surface Ts of a tire T, and programs for detecting a position of a circumferential main groove and calculating a groove depth based on the 3D data G. The circumferential main groove is the groove that is provided along the circumferential direction of the tire, and the deepest groove among grooves provided in the tread part, in which a wear indicator is provided to indicate a use limit of the tire T. The tire T to be inspected may be new, used or in other conditions, that is, the condition of the tire does not matter.

The arithmetic processing means 12 executes and processes the programs stored in the memory means 10, to thereby cause the circumferential main groove detection device 1 to function as each of the means described below.

The input/output means 14 functions as an interface through which 3D data G and other data stored in the memory means 10 is input.

The display means 16 is a so-called monitor or the like, which displays the processing results and so on, acquired by the execution of the programs by the arithmetic processing means 12, and is provided so that a worker can visually recognize the position of the circumferential main groove M, the groove depth D and so on, acquired by the operation of the arithmetic processing means 12.

The input means 18 is a keyboard, mouse and the like, and is provided so that the worker can perform input operation necessary for the detection processing of the circumferential main groove.

As illustrated in FIG. 1B, the circumferential main groove detecting device 1 is provided with a cross-sectional data extracting means 20, an area dividing means 22, an unevenness state evaluating means 24, a groove position detecting means 26, a groove depth calculating means 28, and a groove position determining means 30, and so on.

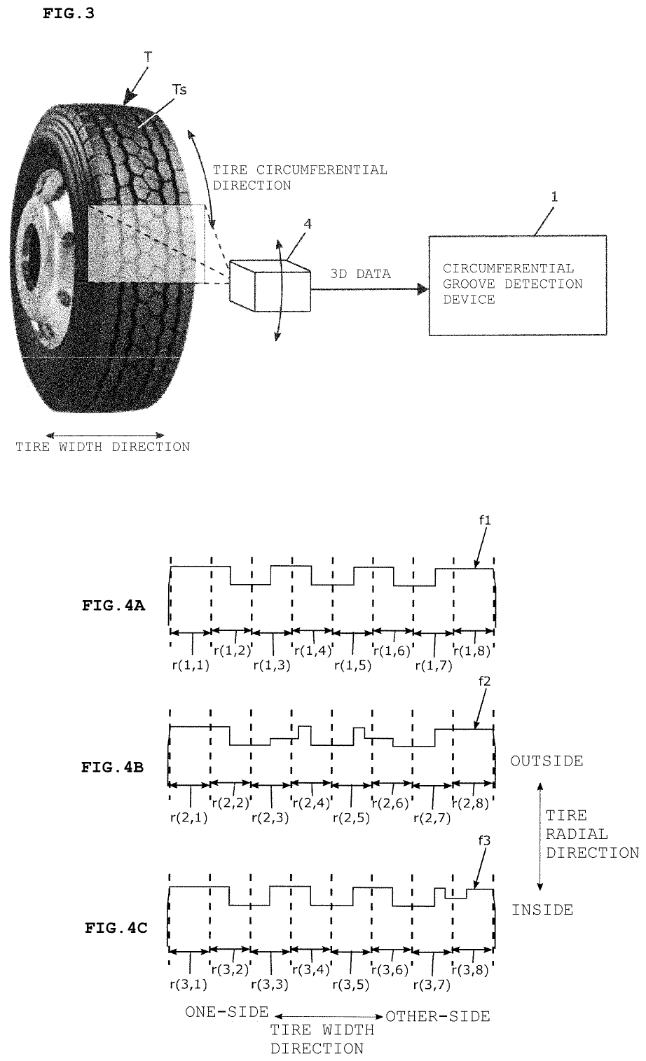

FIGS. 2A and 2B are a conceptual diagram of the 3D data of the tread surface and a schematic diagram of the cross-sectional data extracted from the 3D data. FIG. 3 is a diagram illustrating a manner of acquiring the 3D data of the tread surface;

As illustrated in FIG. 2A, the 3D data G of the tread surface can be acquired by a shape acquiring means 4, such as a non-contact 3D scanner, for example.

As illustrated in FIG. 3, the 3D data G is acquired by facing the 3D scanner against the tread surface Ts of the tire T within a predetermined range so that the groove bottom of the circumferential main groove M is captured, and moving the 3D scanner in the tire circumferential direction in a manner so as to keep the left and right sides of the tire T within the visual field. Incidentally, the 3D data G does not necessarily be such data that was acquired for one round of the tire, but may be such data that was acquired for a part of the tread surface, as illustrated in FIG. 2A.

With the 3D data G acquired in this way, the shape of the tread surface is formed by a plurality of point groups. Three-dimensional positional information that can identify mutual relative positions is associated with each of the points that form the point group.

As illustrated in FIG. 2B, the cross-sectional data extracting means 20 executes the processing for extracting cross-sectional data F on the basis of the 3D data G stored in the memory means 10. Hereinafter, an explanation is given with respect to an example of the processing in the cross-sectional data extracting means 20.

The cross-sectional data extracting means 20, for example, displays the 3D data G stored in the memory means 10 on a display means 16, and executes the processing for prompting the worker to specify, by operating an input means 18, extraction positions p1, p2 and p3 from images of the 3D data G displayed on the display means 16. Then, when the worker specifies the extraction positions p1, p2 and p3 by operating the input means 18, the cross-sectional data F (f1, f2, f3) are extracted on the basis of each of the specified extraction positions p1, p2 and p3.

The cross-sectional data F is the contour shape on the tread surface side of the cut surface in the 3D data G, when cut from one side to the other side of the tire, and is formed by a plurality of point groups. In the present embodiment, the cross-sectional data F is described as the cut surface cut in the tire width direction; however, it is not limited to this, and may be inclined in the tire width direction as long as it is a cross-section cut from the one side to the other side of the tire. The tire width direction referred herein is a direction along a rotation axis of the tire in the 3D data G. In other words, the cross-sectional data F includes the rotation center axis of the tire T and formed of point groups in which a plane passing through the extraction positions p1 to p3 intersects with the 3D data G.

The number of the cross-sectional data F to be extracted by the cross-sectional data extracting means 20 is not limited to three, as illustrated in FIGS. 2A and 2B. The number of the cross-sectional data F may be one or more, and preferably, three or more. By extracting three or more cross-sectional data F, it is possible to improve, in the processing to be performed in a latter stage, a detection accuracy when detecting the circumferential main groove M from the cross-sectional data F and an accuracy of calculation of the groove depth D of the detected circumferential main groove M.

The above-described extraction positions p1 to p3 may be specified from positions different in the tire circumferential direction of the 3D data G displayed on the display means 16. More preferably, the extraction positions p1 to p3 may be specified so that intervals in the tire circumferential direction are differentiated. By specifying the extraction positions p1 to p3 so that the intervals in the tire circumferential direction are differentiated, it is possible to prevent, in the processing of specifying the position of the circumferential main groove M to be performed in the latter stage, misdetection of a transverse groove as the circumferential main groove M when the transverse groove of the same shape exists in all of the extracted cross-sectional data F.

FIGS. 4A to 4C are conceptual diagrams illustrating area division of the cross-sectional data by an area dividing means. As illustrated in FIGS. 4A to 4C, the area dividing means 22 divides, by predetermined number of divisions N, each of the cross-sectional data f1 to f3 evenly along the tire width direction. The number of divisions N may be stored in the memory means 10 in advance, or may be input by prompting the worker to input the number of divisions N in the processing by the area dividing means 22, and causing the worker to operate the input means 18 to input the number of divisions N. The number of divisions N may be set appropriately, for example, may be set in accordance with a tread pattern. In the present embodiment, an explanation is given as the number of divisions N is 8.

Plurality of areas (hereinafter referred to as “divided areas”) set in each cross-sectional data f1 to f3 by the area dividing means 22 are, for example, r(pi, j) and so on, and are numbered from one sequentially from one-end side to the other-end side (from the left side to the right side facing the paper) in the tire width direction, together with the positions (p1 to p3) extracted from the 3D data G, and stored in the memory means 10. Here, i is set to 1 to 3 which is the number of the cross-sectional data, and j is set to 1 to 8 which is the number of the divided areas. Incidentally, when r(pi, j) is shown in a generalized manner, it is simply abbreviated as the divided area r.

The unevenness state evaluating means 24 sets an evaluation value as an index for detecting the circumferential main groove M from each of the cross-sectional data f1 to f3 in accordance with the unevenness state of each of the divided areas r in each of the cross-sectional data f1 to f3. In the present embodiment, two numerical values of 0 and 1 were used as the evaluation values to evaluate by binarizing the unevenness state of each of the divided areas r, and 0 was set for the range corresponding to a concave part and 1 was set for the range corresponding to a convex part.

The evaluation values are set on the basis of the relative positional relationships of the point groups included in each of the divided areas r. For example, by scanning from one side to the other side of the tire in the tire width direction for the point group included in each of the divided areas r, the evaluation value may be set for each set of the point groups (hereinafter referred to as the set group) according to the change of the position of each point in the radial direction.

In other words, the point at the end of one side in the tire width direction among the point groups included in the divided area r is used as a starting point, and positional information in the radial direction associated with this starting point is compared with positional information in the radial direction associated with a point adjacent on the other side to this starting point. If a difference is within a predetermined range (threshold) β, it is determined to form a set group of parts that configure the same shape. This processing is repeated in sequence toward the other side. During the processing, for example, if the difference exceeds the threshold β, it is determined that there is a change in the shape.

In a case where the difference is on the inner side in the tire radial direction, it is determined that the part before being determined as having a change is a set group indicative of a convex part. In a case where the difference is on the outer side in the tire radial direction, it is determined that the part before being determined as having a change is a set group indicative of an area of the concave part. The set groups formed by the judgment are associated with the divided areas r as small areas in the divided areas r. The small area determined to be concave part is assigned an evaluation value of 0, and the small area judged to be convex part is assigned an evaluation value of 1, which are stored in the memory means 10.

That is, in the present embodiment, in the unevenness state evaluating means 24, the evaluation value of the unevenness state of each of the cross-sectional data f1 to f3 is set by the two-step processing.

Hereinafter, an explanation is given as to concrete processing by the unevenness state evaluating means 24. First, the point group included in the divided area r(1,1) is scanned from one side in the tire width direction to check a change, toward the tire radial direction, of a relative distance of points continuing in the tire width direction.

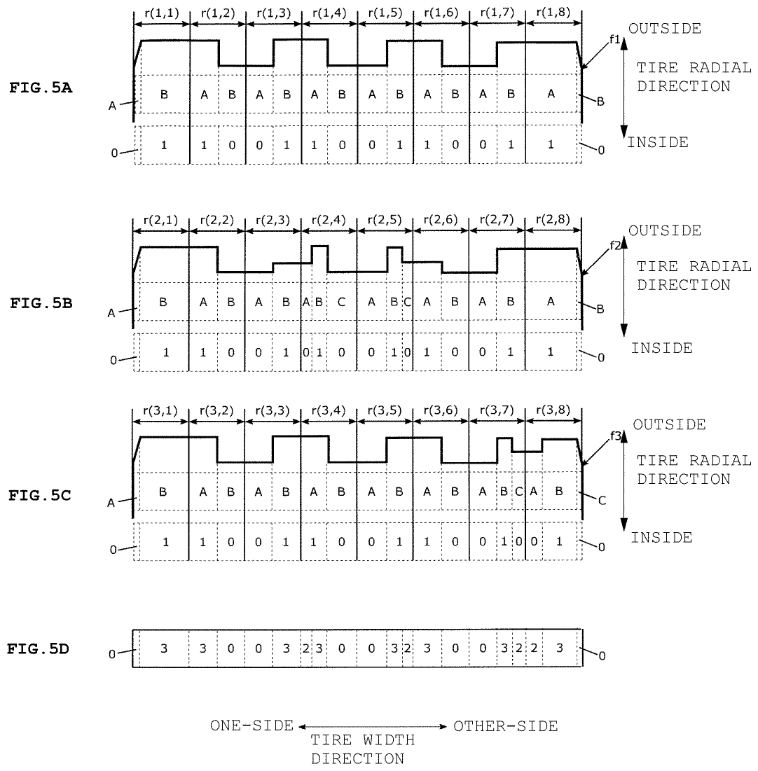

As illustrated in FIG. 5A, the shape of the divided area r(1,1) changes between the point group indicative of the cross-section of one side of the tire and the point group forming the ground surface, so that small areas A and B are set. The point group indicative of one side of the tire is set as the small area A forming a concave part because, with respect to the above-described change in the tire radial direction, the point adjacent to the other-end side of the tire always exceeds the threshold β outwardly in the tire radial direction. In addition, the set group in which the change in the radial direction continues at the threshold β or below is determined as the small area B indicative of a convex part, and 0 is set for the small area A and 1 is set for the small area B.

Similarly, by processing the divided areas r(1,2) to r(1,8) of the cross-sectional data f1, in the divided area r(1,2), the small area A determined as the convex part and the small area B determined as a concave part are set; in the divided area r(1,3), the small area A determined as the concave part and the small area B determined as the convex part are set; in the divided area r(1,4), the small area A determined as the convex part and the small area B determined as the concave part are set; in the divided area r(1,5), the small area A determined as the concave part and the small area B determined as a convex part are set; in the divided area r(1,6), the small area A determined as the convex part and the small area B determined as the concave part are set; in the divided area r(1, 7), the small area A determined as the concave part and the small area B determined as the convex part are set; and in the divided area r(1,8), the small area A determined as the convex part and the small area B determined as the concave part are set.

Then, 1 is set to the small areas determined as the convex part and 0 is set to the small areas determined as the concave part.

Similarly, by processing the divided areas r(2,1) to r(2,8) of the cross-sectional data f2, as illustrated in FIG. 5B, in the divided area r(2,1), the small area A determined as the concave part and the small area B determined as the convex part are set; in the divided area r(2,2), the small area A determined as the convex part and the small area B determined as the concave part are set; in the divided area r(2, 3), the small area A determined as the concave part and the small area B determined as the convex part are set; in the divided area r(2,4), the small area A determined as the concave part, the small area B determined as the convex part, and the small area C determined as the concave part are set; in the divided area r(2,5), the small area A determined as the concave part, the small area B determined as the convex part, and the small area C determined as the concave part are set; in the divided area r(2,6), the small area A determined as the convex part and the small area B determined as the concave part are set; in the divided area r(2, 7), the small area A determined as the concave part and the small area B determined as the convex part are set; and in the divided area r(2,8), the small area A determined as the convex part and the small area B determined as the concave part are set.

Then, 1 is set for the small areas determined as the convex part, and 0 is set for the small areas determined as the concave part.

Similarly, by processing the divided areas r(3,1) to r(3,8) of the cross-sectional data f3, as illustrated in FIG. 5C, in the divided area r(3,1), the small area A determined as the concave part and the small area B determined as the convex part are set; in and the divided area r(3,2), the small area A determined as the convex part and the small area B determined as the concave part are set; in the divided area r(3,3), the small area A determined as the concave part and the small area B determined as the convex part are set; in the divided area r(3,4), the small area A determined as the convex part and the small area B determined as the concave part are set; in the divided area r(3, 5), the small area A determined as the concave part and the small area B determined as the convex par are set; in the divided area r(3,6), the small area A determined as the convex part and the small area B determined as the concave part are set; in the divided area r(3,7), the small area A determined as the concave part, the small area B determined as the convex part and the small area C determined as the concave part are set; and in the divided area r(3,8), the small area A determined as the concave part, the small area B determined as the convex part and the small area C determined as the concave part are set.

Then, 1 is set for the small areas determined as the convex part, and 0 is set for the small areas determined as the concave part.

The groove position detecting means 26 functions as a circumferential main groove detecting means that detects, by using the evaluation values set in each of the cross-sectional data f1 to f3, the position of the circumferential main groove M in each of the cross-sectional data f1 to f3. The groove position detecting means 26 calculates a total value of evaluation values of the divided areas r located at the same position in the tire circumferential direction, among the evaluation values set in each of the cross-sectional data f1 to f3. In the present embodiment, the total value of the evaluation values is calculated for each of the divided areas r, which are located at the same position in the tire circumferential direction, of each of the cross-sectional data f1 to f3.

Specifically, the groove position detecting means 26 determines whether or not small areas are set in the first divided areas (1-3, 1) in the tire width direction. As a result of the determination, since small areas A and B are set in each of the divided area (1-3, 1), information on the position and range in the tire width direction associated with each of the small areas A and B of the divided areas (1-3, 1) is acquired. Next, the range of the small areas A of the divided areas (1-3, 1) and the range of the small areas B of the divided areas (1-3, 1) are compared. As a result of the comparison, since the range of the small areas A of the divided areas (1-3, 1) are the same and the range of the small areas B of the divided areas (1-3, 1) are the same, the total value 0 of the evaluation values set for the small areas A at the same position in the circumferential direction and the total value 3 of the evaluation values set for the small areas B at the same position in the circumferential direction are calculated.

Next, it is determined whether or not small areas are set in the second divided areas (1-3, 2) in the tire width direction. As a result of the determination, since small areas A and B are respectively set in each of the divided areas (1-3,2), information on the range in the tire width direction of each of the small areas A and B of the divided areas (1-3, 2) is acquired.

Next, the range of the small areas A of the divided areas (1-3, 2) and the range of the small areas B of the divided areas (1-3, 2) are compared. As a result of the comparison, since the ranges of the small areas A of the divided areas (1-3, 2) are the same and the ranges of the small areas B of the divided areas (1-3, 2) are the same, the total value 3 of the evaluation values set for the small areas A at the same position in the circumferential direction and the total value 0 of the evaluation values set for the small areas B at the same position in the circumferential direction are calculated.

Next, with respect to the third divided areas (1-3, 3) in the tire width direction, by performing the similar processing as for the divided areas (1-3, 2), the total value 0 of the evaluation values set for the small areas A at the same position in the circumferential direction and the total value 3 of the evaluation values set for the small areas B at the same position in the circumferential direction are calculated.

Next, the presence or absence of the setting of small areas in the fourth divided areas (1-3, 4) in the tire width direction is determined. As a result of the determination, since two small areas A and B are set respectively in each of the divided areas (1;3, 4), and three small areas A, B and C are set in the divided area (2,4), information on the range in the tire width direction of each of the small areas A and B of each of the divided areas (1;3, 4) and information on the range in the tire width direction of each of the small areas A, B, and C of the divided area (2,4) are acquired.

Next, the range of each of the small areas A and B of each of the divided areas (1;3, 4) is compared with the range of each of the small areas A, B and C of the divided area (2,4). As a result of the comparison, since the ranges of the small areas A and B of the divided area (2,4) coincide with the range of the small area A of the divided area (1,4) and the range of the small area A of the divided area (3, 4), and the range of the small area C of the divided area (2,4) coincides with the range of the small area B of the divided area (1,4) and the range of the small area B of the divided area (3,4), the total value 2 of the evaluation value set for the small area A of the divided area (2,4), of the evaluation value set for the small area A of the divided area (1,4) and of the evaluation value set for the small area A of the divided area (3,4) including the same position in the tire circumferential direction is calculated.

The total value 3 of the evaluation value set for the small area B of the divided area (2,4), of the evaluation value set for the small area A of the divided area (1,4) and of the evaluation value set for the small area A of the divided area (3,4) including the same position in the tire circumferential direction is calculated.

The total value 0 of the evaluation value set for the small area C of the divided area (2,4), of the evaluation value set for the small area B of the divided area (1,4) and of the evaluation value set for the small area B of the divided area (3,4) including the same position in the tire circumference direction is calculated, and the processing of calculating the evaluation values of the divided areas (1-3, 4) is finished.

By repeating the above-described processing up to the divided areas r (1-3, 8), the total value of the evaluation values of each of the divided areas (1-3, 5-8) is calculated. The calculated total value is output, together with the position in the tire width direction and its range, to the memory means 10 and stored therein.

Then, in the groove position detecting means 26, the range with the total value 0 in the tire width direction is stored as the circumferential main groove M common to the cross-sectional data f1 to f3. Specifically, as illustrated in FIG. 5D, in the cross-sectional data f1, the small area B of the divided area r(1,2) and the small area A of the divided area r(1,3) are stored as a circumferential main groove m1, the small area B of the divided area r(1,4) and the small area A of the divided area r(1,5) are stored as a circumferential main groove m2, and the small area B of the divided area r(1,6) and the small area A of the divided area r(1,7) are stored as a circumferential main grooves m3. Further, in the cross-sectional data f2, the small area B of the divided area r(2, 2) and the small area A of the divided area r(2,3) are stored as the circumferential main groove m1, the small area C of the divided area r(2,4) and the small area A of the divided area r(2,5) are stored as the circumferential main groove m2, and the small area B of the divided area r(2,6) and the small area A of the divided area r(2, 7) are stored as the circumferential main groove m3. In the cross-sectional data f3, the small area B of the divided area r(3, 2) and the small area A of the divided area r(3,3) are stored as the circumferential main groove m1, the small area B of the divided area r(3,4) and the small area A of the divided area r(3,5) are stored as the circumferential main groove m2, and the small area B of the divided area r(3,6) and the small area A of the divided area r(3,7) are stored as the circumferential main groove m3.

Incidentally, other than the total value of 0, for example, the range of the total value of 3 may be stored in the memory means 10 as the land part, and the range of the total value of 2 may be stored in the memory means 10 as being other than the circumferential main groove M and the land part.

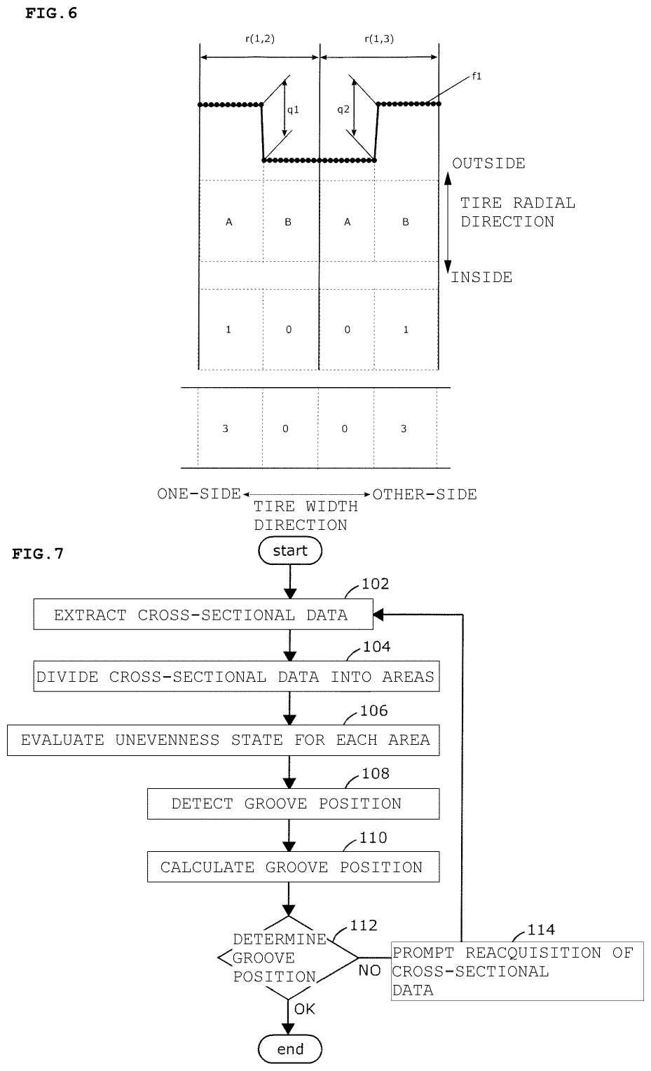

FIG. 6 is a conceptual diagram of the processing of calculating a groove depth by a groove depth calculating means. The groove depth calculating means 28 calculates, for each of the cross-sectional data f1 to f3, each of groove depths Dm1 to Dm3 of each of the circumferential main grooves m1 to m3, on the basis of the small areas of the divided areas set, by the groove position detecting means 26, in each of the cross-sectional data f1 to f3 as the circumferential main grooves m1 to m3.

Hereinafter, an explanation is given as to the processing of calculating the circumferential main grooves m1 to m3 by the groove depth calculating means 28.

The groove depth calculating means 28 calculates the groove depths Dm1 to Dm3 on the basis of differences, in positions in the radial direction, between the small areas of the divided areas set as the circumferential main grooves m1 to m3 and the divided areas for which the evaluation value has been set to 1 and which are adjacent to the small areas of the divided areas set as the circumferential main grooves m1 to m3 and for which the evaluation value has been set to 1.

An explanation is given as to the case of calculating the groove depth Dm1 of the circumferential main groove m1 in the cross-sectional data f1.

Because the circumferential main groove m1 in the cross-sectional data f1 has been set to be formed by the small area B of the divided area r(1,2) and the small area A of the divided area r(1,3), a difference, in positions in the radial direction, between the small area B of the divided area r(1,2) and the small area A of the divided area r(1,2) which is adjacent to the small area B of the divided area r(1,2) and for which the evaluation value of 1 has been set, and a difference, in positions in the radial direction, between the small area A of the divided area r(1, 3) and the small area B of the divided area r(1,3) which is adjacent to the small area A of the divided area r(1,3) and for which the evaluation value of 1 has been set, are calculated.

Specifically, a difference in the radial direction between the point, among the group of points included in the small area B of the divided area r(1,2), located nearest to the side of the small area A of the divided area r(1,3) and the point, among the group of points included in the small area A of the divided area r(1,3), located nearest to the side of the small area B of the divided area r(1,2), is calculated. Hereinafter, this difference is referred to as a one-side difference q1. Next, a difference in the radial direction between the point, among the group of points included in the small area A of the divided area r(1,3), located nearest to the side of the small area B of the divided area r(1,3) and the point, among the group of points included in the small area B of the divided area r(1,3), located nearest to the side of the small area A of the divided area r(1,3), is calculated.

Hereinafter, this difference is referred to as an other-side difference q2.

Then, the one-side difference ql and the other-side difference q2 are compared, and when the difference is equal to or less than a predetermined threshold y, for example, the one-side difference q1 or the other-side difference q2 is set as the groove depth Dm1 of the circumferential main groove m1 in the cross-sectional data f1.

For example, when the difference is greater than the threshold value y, the larger value between the one-side difference ql and the other-side difference q2 is set as the groove depth Dm1.

This processing is performed for calculating the circumferential main grooves m2 and m3 in the cross-sectional data f1, the circumferential main grooves m1 to m3 in the cross-sectional data f2, and the circumferential main grooves m1 to m3 in the cross-sectional data f3.

The groove position determining means 30 compares the groove depths Dm1 to Dm3 of the circumferential main grooves m1 to m3 respectively calculated in each of the cross-sectional data f1 to f3 by the groove depth calculating means 28, and determines whether or not the positions of the circumferential main grooves m1 to m3 set in each of the cross-sectional data f1 to f3 are correct.

In particular, the groove depths Dm1 of the circumferential main grooves m1 respectively calculated in each of the cross-sectional data f1 to f3 are compared. As the method of comparing the groove depths Dm1, for example, the deepest groove depth (referred to “the deepest groove depth”) Dm1 is detected from the three groove depths Dm1, and when a difference from the deepest groove depth Dm1 is within a predetermined threshold Z, the position concerned is determined to be the circumferential main groove m1.

When the difference exceeds or equal to or less than the predetermined threshold Z, the position of the circumferential main groove m1 is determined to be, for example, if a shallow groove exists, that shallow circumferential main groove is determined to be in a stone-biting state, or to be a wear indicator, and the worker is notified to extract, from the 3D data G, new cross-sectional data in lieu of the cross-sectional data concerned.

FIG. 7 is a flowchart illustrating the processing in the circumferential main groove detection device.

First, by the cross-sectional data extracting means 20, the 3D data G stored in the memory means 10 is read and the plurality of cross-sectional data f1 to f3 are extracted from the 3D data G (S102).

Next, by the area dividing means 22, each of the cross-sectional data f1 to f3 is divided at equal intervals in the tire width direction, and the plurality of divided areas r are set in each of the cross-sectional data f1 to (S104).

Next, by the unevenness state evaluating means 24, a evaluation value of 0 for concave parts or 1 for convex parts is set, for example, in accordance with the unevenness state of the divided areas r set in each of the cross-sectional data f1 to f3 (S106).

Next, by the groove position detecting means 26, with respect to the evaluation value set for each of the divided areas r in each of the cross-sectional data f1 to f3, the total value of the evaluation values set for each of the divided areas r in the shape data f1 to f3 at the same position in the tire circumferential direction is calculated, and the divided areas r with the calculated total value of 0 are set to be the circumferential main groove M (S108).

Next, by the groove depth calculating means 28, the groove depth D is calculated on the basis of a difference in the tire radial direction between the position of the divided area r set to be the circumferential main groove M in 5108 and the position of the divided area r which is adjacent to the divided area r set to be the circumferential main groove M in each of the cross-sectional data f1 to f3 and for which the evaluation value of 1 has been (S110).

Next, the groove position determining means 30 compares the groove depths, calculated by the groove depth calculation means 28, at the same position in the tire circumferential direction of the divided areas r in each of the cross-sectional data f1 to f3. In a case where the groove depths at the same position in the tire circumferential direction are the same, it is judged that there is no abnormality and the processing is terminated (S112).

In a case where the groove depths D at the same position in the tire circumferential direction are different (shallow), this is displayed on the display means 16 as there is an abnormality, and the worker is prompted to extract, from the 3D data 0, cross-sectional data in lieu of the cross-sectional data including the shallow circumferential main groove M, and returns to S102 to prompt the worker to newly specify the cross-sectional data (S114).

Then, S102 to S112 are repeated until it is judged that there is no abnormality in S112.

As described above, according to the present embodiment, it is possible to detect, the position of the main circumferential groove M by simple processing without acquiring all the uneven shapes of the tread surface Ts (for one tire circumference), unlike the conventional practice. In other words, in the present embodiment, a plurality of cross-sectional data F are extracted from the 3D data G of the tread surface Ts, the extracted cross-sectional data F are divided into a plurality of areas, the unevenness in the tread surface Ts is evaluated for each of the divided areas, and according to the evaluation, the position of the circumferential main groove M is acquired on the basis of the evaluation values set for the divided areas. Therefore, it is possible to eliminate the need for complicated calculations. In addition, because the position of the circumferential main groove M is detected on the basis of the cross-sectional data F, the groove depth D of the circumferential main groove M common to each of the cross-sectional data F can be calculated. That is, by acquiring the cross-sectional data F of a specific position from the 3D data F, the groove depth D at the specific position can be acquired.

In the present embodiment, it has been explained that the worker extracts the plurality of cross-sectional data F from the 3D data G displayed on the display means 16 by operating the input means 18; however, without being limited thereto, it may be arranged to automatically extract the data. F from the 3D data G stored in the memory means 10. In this case, for example, a plurality of cross-sectional data may be extracted by setting extraction positions in such a manner that the end part in the tire circumferential direction in the 3D data G is set as a reference position, a position that is apart for predetermined pixels toward the tire circumferential direction from the reference position is set as a first extraction position, and a position that is apart for predetermined pixels toward the tire circumferential direction from the first extraction position is set as a second extraction position. The first extraction position is a predetermined pixel distance from the first extraction position.

Incidentally, the evaluation value set fbr the divided area r(i, j) is not limited to the binary value of 0, 1 as described above; however, it may be such that numerical values such as 0, 1, 2, (m is any positive numerical value greater than or equal to 2) are assigned to represent by subdividing the shape. From the viewpoint of speeding up the processing, it is preferable that the numbers set for evaluation values be lesser, and from the viewpoint of accuracy, the numbers may be subdivided so that the numerical values indicative of the shape are divided into appropriate steps.

Further, in the above-described embodiment, numerical values are set as the evaluation values; however, the evaluation value is not limited to the numerical value, a character such as an alphabet or a symbol may also be set. In this case, it may be arranged such that, in the groove position detecting means 26, the position of the circumferential main groove M is detected in correspondence with a combination of characters such as alphabet, or a combination of symbols.

Furthermore, in the present embodiment, it has been explained that the cross-sectional data F is extracted from the 3D data G stored in the memory means 10; however, it may be arranged such that the cross-sectional data F acquired in advance from the inspection-target tire T is stored in the memory means 10.

In other words, in the present embodiment, it has been explained that the 3D scanner is used as the shape acquiring means 4; however, by using, for example, a line camera instead of the 3D scanner, the cross-sectional data F can be directly acquired, and the acquired data can be directly stored in the memory means 10. In this case, it is preferable to acquire three or more cross-sectional data F by the line camera and store the acquired data in the memory means 10. With this arrangement, it is possible to omit the cross-sectional data extracting means 20 in the circumferential main groove detection device 1.

Furthermore, the circumferential main groove detection device 1 may be configured such that, without omitting the cross-sectional data extracting means 20, the processing by the cross-sectional data extracting means 20 is selectively omitted in accordance with the information indicative of the shape of the tread surface (3D data or cross-sectional data by direct input) to be stored in the memory means 10.

Furthermore, the tire inspection system may be configured by integrating the shape acquiring means 4, which is capable of acquiring the above-mentioned 3D data G or directly acquiring the cross-sectional data, into the circumferential main groove detection device 1 according to the present embodiment.

In the present embodiment, it has been explained that the 3D scanner as the shape acquiring means 4 is used to acquire the 3D data; however, it is not limited to the 3D scanner and any means that can acquire the unevenness shape of the tread surface as three-dimensional information may be sufficient For example, it may be acquired by using a still camera, a video camera or the like, and processing a predetermined image on the basis of the images taken by the still camera, the video camera or the like.

In the case of directly acquiring the above-described cross-sectional data F, the photographing range of the line camera may be set to extend in the tire width direction, and the data may be acquired by moving the line camera in the circumferential direction of the tire T to shoot different positions in the circumferential direction.

The 3D data G or the cross-sectional data F can be easily acquired, for example, in such a manner that the worker takes pictures by holding a shape acquiring means such as the line camera, the still camera, the video camera or the like. When taking pictures, it is preferable that the line camera is placed to be directly opposite to the tread surface Ts of the tire, and the photographing range is so set that the photographing range extends in the tire width direction. Preferably, the end part in the tire width direction may be included in the photographing range.

In summary, the present invention can be described as follows.

Namely, as an aspect of the circumferential main groove detection method, there is provided a circumferential main groove detection method for detecting, by a computer, a position of a circumferential main groove of a tire from 3D data of a tread surface of the tire, the method including: a cross-sectional data extracting step of extracting, at a plurality of places in a tire circumferential direction, cross-sectional data of the tread surface along one direction inclined with respect to the tire circumferential direction; an area dividing step of dividing the cross-sectional data respectively into a plurality of areas along one direction; an evaluating step of evaluating relative unevenness in the areas; and a circumferential main groove identifying step of overlaying evaluation results of divided areas at an identical position in the tire circumferential direction and identifying the position of the tire circumferential main groove.

According to this aspect, the position of the circumferential main groove of the tire can be easily detected.

As another aspect of the circumferential main groove detection method, in the cross-sectional data extraction step, the cross-sectional data may be extracted from three or more positions that are different in the circumferential direction.

Aa a still another aspect of the circumferential main groove detection method, the cross-sectional data may be extracted at intervals that are different in the circumferential direction.

Further, in the evaluation step, the unevenness may be evaluated by a numeral value.

Further, in the circumferential main groove identifying step, the position of the circumferential main groove of the tire may be identified by a total value of numerical values set for each area by the evaluation step.

Furthermore, the method may include a groove depth calculating step of calculating a groove depth of the circumferential main groove using an area which is adjacent to the area identified as the circumferential main groove and which is identified as being other than the circumferential main groove in the circumferential main groove identification step.

In addition, as an aspect of the circumferential main groove detection device for solving the above-mentioned problems, there is provided a circumferential main groove detection device that detects a position of a circumferential main groove of a tire from 3D data of a tread surface of the tire, the device including: a cross-sectional data extracting means that extracts, at a plurality of places in a tire circumferential direction, cross-sectional data of the tread surface along one direction inclined with respect to the tire circumferential direction; an area dividing means that divides the cross-sectional data respectively into a plurality of areas along one direction; an unevenness state evaluating means that evaluates relative unevenness in the areas; and a circumferential main groove detecting means that overlays evaluation results of divided areas at an identical position in the tire circumferential direction and identifies the position of the circumferential main groove of the tire.

### REFERENCE SIGN LIST

1: circumferential main groove detection device, 4: shape acquiring means. 10: memory means, 12: arithmetic processing means, 14: input/output means, 16: display means, 18: input means, 20: dross-sectional data extracting means, 22: area dividing means, 24: unevenness state evaluating means, 26: groove position detecting means, 28: calculating means, 30: groove position determining means, A to C: small area, F: f1 to f3 cross-sectional (shape/ data, G: 3D data, M: m1 to m3 circumferential main groove, D: Dm1 to Dm3 groove depth, N: number of divisions, p1, p2, p3: extraction position, q1: one-side difference, q2: other-side difference, r: divided area, T: tire. Ts: tread surface. Z: threshold value.

1. A circumferential main groove detection method for detecting, by a computer, a position of a circumferential main groove of a tire from 3D data of a tread surface of the tire, the method comprising:
a cross-sectional data extracting step of extracting, at a plurality of places in a tire circumferential direction, cross-sectional data of the tread surface along one direction inclined with respect to the tire circumferential direction;
an area dividing step of dividing the cross-sectional data respectively into a plurality of areas along one direction;
an evaluating step of evaluating relative unevenness in the areas; and
a circumferential main groove identifying step of overlaying evaluation results of divided areas at an identical position in the tire circumferential direction and identifying the position of the tire circumferential main groove.

2. The circumferential main groove detection method according to claim 1, wherein in the cross-sectional data extracting step, the cross-sectional data are extracted from three or more positions that are different in the circumferential direction.

3. The circumferential main groove detection method according to claim 1, wherein in the cross-sectional data extracting step, the cross-sectional data are extracted at intervals that are different in the circumferential direction.

4. The circumferential main groove detection method according to claim 1, wherein in the evaluating step, the unevenness is evaluated by a numeral value.

5. The circumferential main groove detection method according to claim 4, wherein, in the circumferential main groove identifying step, the position of the circumferential main groove of the tire is identified by a total value of numerical values set for each area by the evaluating step.

6. The circumferential main groove detection method according to claim 1, wherein the method includes a groove depth calculating step of calculating a groove depth of the circumferential main groove using an area which is adjacent to the area identified as the circumferential main groove and which is identified as being other than the circumferential main groove in the circumferential main groove identification step.

7. A circumferential main groove detection device that detects a position of a circumferential main groove of a tire from 3D data of a tread surface of the tire, the device comprising:
a cross-sectional data extracting means that extracts, at a plurality of places in a tire circumferential direction, cross-sectional data of the tread surface along one direction inclined with respect to the tire circumferential direction;
an area dividing means that divides the cross-sectional data respectively into a plurality of areas along one direction;
an unevenness state evaluating means that evaluates relative unevenness in the areas; and
a circumferential main groove detecting means that overlays evaluation results of divided areas at an identical position in the tire circumferential direction and identifies the position of the circumferential main groove of the tire.
